(19) United States
(12) Patent Application Publication
(10) Pub. No.: US 2022/0114550 A1
(43) Pub. Date: Apr. 14, 2022

(54) Delivery Exchange Service and Infrastructure

(71) Applicant: Honda Motor Co., Ltd., Tokyo (JP)

(72) Inventor: Boris Hernan Polania CASTRO, Cupertino, CA (US)

(73) Assignee: Honda Motor Co., Ltd.

(21) Appl. No.: 17/070,446

(22) Filed: Oct. 14, 2020

(51) Int. Cl. G06Q 10/08

(52) U.S. Cl. CPC G06Q 10/08355; G06Q 10/08345

(57) ABSTRACT

A method and system for providing a delivery exchange service infrastructure are described. In one embodiment, a method for a delivery exchange service is provided. The method includes receiving, at a user interface associated with a first user, a notification from at least one merchant indicating an availability of a new delivery of a parcel to a recipient. The method also includes comparing a fee for the new delivery to a fee for an existing delivery. Upon determining that the fee for the new delivery is more than the fee for the existing delivery, the method includes determining whether a second user is available to receive a transfer of the existing delivery. Upon determining that the second user is available, the method further includes accepting the new delivery and transferring the existing delivery to the second user.

### BACKGROUND

The embodiments relate generally to delivery services, and in particular to a method and system for providing a delivery exchange service and infrastructure.

As consumer shopping for goods over the internet and through mobile device applications becomes more common, the need for a delivery service infrastructure to support delivery of consumer purchases to the purchaser's home is also growing and expanding. Existing delivery service providers, such as the United States Postal Service, FedEx, UPS, etc., may not have sufficient resources to meet this growing demand. As a result, there has been an increase in user-based delivery service providers that offer “last-mile” delivery of goods to the purchaser's home. The existing delivery service infrastructure, however, lacks an effective mechanism to allow for the exchange of deliveries between these various delivery service providers to provide a more efficient and cost-effective last-mile delivery to the purchaser's home.

### SUMMARY

The techniques of the present embodiments described herein provide a method and system for providing a delivery exchange service and infrastructure that allows various delivery service provides to exchange deliveries to one or more recipients in a manner that is cost-effective and efficient.

In one aspect, a method for a delivery exchange service is provided. The method includes receiving, at a user interface associated with a first user, a notification from at least one merchant indicating an availability of a new delivery of a parcel to a recipient. The method also includes comparing a fee for the new delivery to a fee for an existing delivery. Upon determining that the fee for the new delivery is more than the fee for the existing delivery, the method includes determining whether a second user is available to receive a transfer of the existing delivery. Upon determining that the second user is available, the method further includes accepting the new delivery and transferring the existing delivery to the second user.

In another aspect, a system for providing a delivery exchange service infrastructure is provided. The system including a delivery exchange service provider. The delivery exchange provider including at least one processor, a user interface, a communication interface, and a database. The system also including a plurality of merchants in communication with the delivery exchange service provider. Each merchant of the plurality of merchants having parcels for delivery to one or more recipients. The system further including a plurality of users in communication with the delivery exchange service provider. Each user of the plurality of users accepting a fee for delivery of a parcel to the one or more recipients. The delivery exchange service provider is configured to send a notification to at least one user of the plurality of users indicating an availability of a new delivery of a parcel from at least one of the plurality of merchants to a recipient.

In another aspect, a method for a delivery exchange service is provided. The method including receiving, at a user interface associated with a first user, a notification from at least one merchant indicating an availability of a new delivery of a parcel to a first recipient. The method including comparing a fee for the new delivery to a fee for an existing delivery. Upon determining that the fee for the new delivery is not more than the fee for the existing delivery, the method includes determining whether more than one recipient is located within a predetermined distance of a location of the new delivery to the first recipient. Upon determining that the more than one recipient is located within the predetermined distance, accepting each new delivery to one or more recipients located within the predetermined distance.

Other systems, methods, features and advantages of the exemplary embodiments will be, or will become, apparent to one of ordinary skill in the art upon examination of the following figures and detailed description. It is intended that all such additional systems, methods, features and advantages be included within this description and this summary, be within the scope and protected by the claims.

### BRIEF DESCRIPTION OF THE DRAWINGS

The exemplary embodiments may be better understood with reference to the following drawings and description. The components in the figures are not necessarily to scale. Moreover, in the figures, like reference numerals designate corresponding parts throughout the different views.

FIG. 1 is a schematic view of an example embodiment of a system for providing a delivery exchange service infrastructure;

FIG. 2 is a schematic view of an example embodiment of user interfaces for a delivery exchange service infrastructure;

FIG. 3 is a flowchart of an example embodiment of a method for a delivery exchange service;

FIG. 4 is a representative view of an example scenario of a user using the delivery exchange service;

FIG. 5 is a representative view of an example scenario of a user receiving an alert of a higher-paying delivery by the delivery exchange service;

FIG. 6 is a representative view of an example scenario of a user using the delivery exchange service to exchange a lower-paying delivery for a higher-paying delivery;

FIG. 7 is a representative view of an example scenario of a user receiving an alert of a combined delivery by the delivery exchange service; and

FIG. 8 is a representative view of an example scenario of a user using the delivery exchange service to exchange a single delivery for a combined delivery.

### DETAILED DESCRIPTION

The example embodiments described herein provide a method and system for providing a delivery exchange service and infrastructure. The techniques described herein allow delivery service providers, including delivery service companies and user-based delivery service providers, to exchange specific parcel deliveries to recipients in a manner that encourages cost-effectiveness and efficiency. Coordination of the deliveries using the delivery exchange service of the example embodiments allows users to determine which deliveries will generate the highest fees so that lower-paying deliveries may be exchanged with other users who can deliver the parcel at a lower cost.

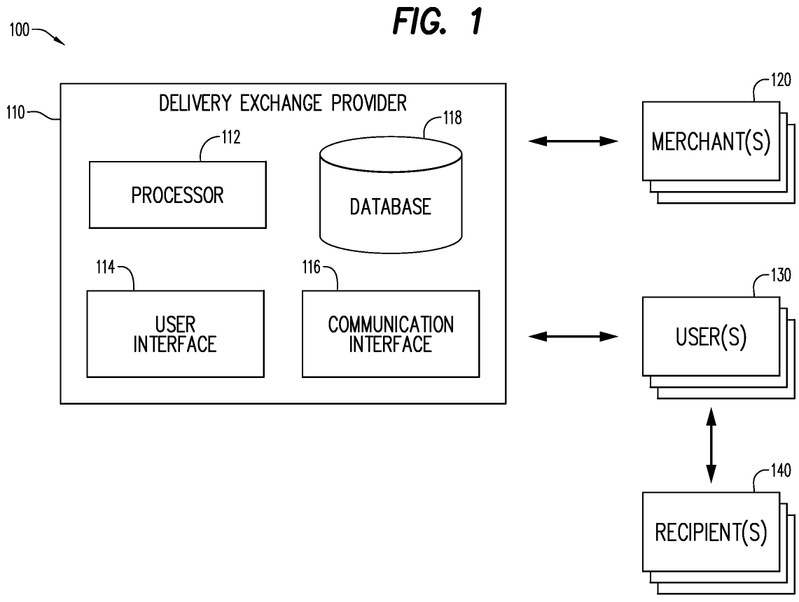

FIG. 1 illustrates a schematic diagram of an embodiment of a system 100 for providing a delivery exchange service infrastructure. In an example embodiment, system 100 may include a delivery exchange service provider 110, a plurality of participating merchants 120, a plurality of users 130, and a plurality of recipients 140. Delivery exchange service provider 110 may include hardware, software, and components that are configured to communicate with plurality of participating merchants 120 and plurality of users 130 to receive and transmit information associated with one or more parcel deliveries to plurality of recipients 140.

In an example embodiment, plurality of merchants 120 and/or plurality of users 130 may elect to participate in the delivery exchange service infrastructure provided by delivery exchange service provider 110. For example, delivery exchange service provider 110 may provide support for the delivery exchange service infrastructure by signing up merchants who are interested in paying delivery fees for parcel deliveries to one or more of plurality of recipients 140, users who are interested in receiving delivery fees for providing “last-mile” delivery services of the merchants' parcels to one or more of plurality of recipients 140, or parties who may participate as both.

In this embodiment, delivery exchange service provider 110 may include a processor 112 that is in communication with at least a user interface 114, a communication interface 116, and a database 118. In some embodiments, delivery exchange service provider 110 may include other components not shown in FIG. 1 to facilitate receiving and transmitting notifications or requests from merchants 120 or users 130, providing fee information for parcel deliveries, and providing information to users 130 to effectuate delivery to one or more of recipients, such as a recipient's name, address, parcel identification or tracking number, etc., according to the example embodiments described herein.

In some embodiments, user interface 114 may be configured to allow one or more merchants of plurality of merchants 120 and/or one or more users of plurality of users 130 to interact with delivery exchange service provider 110. For example, in one embodiment, user interface 114 may interact with merchants of plurality of merchants 120 and users of plurality of users 130 through an application (e.g., mobile app) or website. Merchants and/or users of the delivery exchange service infrastructure may sign up with delivery exchange service provider 110 through user interface 114. In some embodiments, user interface 114 may interact with the participating merchants and/or users of the delivery exchange service infrastructure via a connection with a wired or wireless telecommunication network available through communication interface 116.

Communication interface 116 may be configured to allow delivery exchange service provider 110 to send and/or receive messages or alerts to merchants and/or users of the delivery exchange service infrastructure about parcel deliveries to plurality of recipients 140. For example, in one embodiment, communication interface 116 may be a wireless transceiver that transmits and/or receives signals (e.g., commands, messages, information, etc.) to and/or from plurality of merchants 120 and/or users of plurality of users 130.

Plurality of merchants 120 includes one or more merchants, companies, persons, businesses, or other entities that have a parcel for delivery to at least one recipient (e.g., one or more of plurality of recipients 140). In some embodiments, plurality of merchants 120 may include retail businesses that sell any of a variety of different goods for delivery to recipients 140. Plurality of merchants 120 may use delivery exchange service infrastructure to make these parcel deliveries available to one or more of plurality of users 130 for a fee in exchange for delivering the parcel to the recipient. For example, plurality of merchants 120 may list or post one or more parcel deliveries along with the associated fee to the user (i.e., the party delivering the parcel delivery to the recipient) through delivery exchange service provider 110. With this arrangement, merchants may easily and conveniently arrange for delivery of parcel deliveries to recipients.

In some embodiments, the fee may be set in advance by the merchant offering the parcel delivery, for example, based on weight, distance, size, or other factors associated with the parcel. In other embodiments, the fee may be a flat fee set by the merchant for delivery of the parcel to the recipient. In still other embodiments, the fee may be offered by users as bids or proposals for delivering the parcel, similar to an auction-style listing where each user may compete with other users to offer a lower delivery fee.

In some embodiments, plurality of merchants 120 may also include existing delivery service providers, such as the United States Postal Service, FedEx, UPS, or other delivery service providers. In these embodiments, a parcel delivery currently in possession and under the responsibility of the existing delivery service provider may be transferred to one or more of plurality of users 130 for a fee in exchange for delivering the parcel to the recipient. For example, an existing delivery service provider may not have sufficient drivers or coverage in a given geographic area. Accordingly, the existing delivery service provider may find it to be more cost effective and efficient to offer a fee to plurality of users 130 through delivery exchange service provider 110 to provide the “last-mile” delivery to the recipient.

Plurality of users 130 includes one or more persons or parties who deliver a parcel to the recipient in exchange for a fee. Plurality of users 130 may include user-based delivery service providers that use employees or independent contractors to delivery parcels to recipients, as well as individuals who sign up with delivery exchange service provider 110 to be delivery drivers. In some embodiments, delivery exchange service provider 110 may also employ its own delivery drivers as one or more of plurality of users 130.

Additionally, in some embodiments, plurality of users 130 may include one or more autonomous vehicles that are configured to travel from one location to a destination without requiring a human operator. For example, plurality of users 130 may include a fleet of autonomous vehicles that are loaded with one or more parcels for delivery to recipients at a central location, such as a distribution hub or other shipping facility, and are controlled to autonomously travel to the recipient to deliver the parcel.

Plurality of recipients 140 include one or more persons or entities, such as a businesses, companies, institutions, etc., that are receiving a parcel delivery from plurality of merchants 140. In an example embodiment, plurality of recipients 140 need not communicate or otherwise interact with delivery exchange service provider 110 to take delivery of their parcel via delivery exchange service infrastructure. That is, to the recipient, the mechanisms of effectuating completion of parcel deliveries using delivery exchange service infrastructure does not appear different from deliveries received from existing delivery service providers. With this arrangement, the delivery exchange service infrastructure according the techniques presented herein may be provided to allow parcel deliveries to recipients in a manner that is cost-effective and efficient.

FIG. 1 illustrates a representative plurality of merchants 120, plurality of users 130, and plurality of recipients 140 for the purpose of explanation, however, it should be understood that the delivery exchange service infrastructure according to the present embodiments may include any number of merchants, users, and/or recipients.

In an example embodiment, one or more listings or postings of available parcel deliveries to recipients (e.g., from plurality of merchants 130) may be stored using database 118. For example, database 118 may include information about the parcel to be delivered, including the recipient's location, the associated fee provided for delivery of the parcel, and/or a tracking number or other identifier to distinguish the parcel from other parcels.

In some embodiments, database 118 may include information associated with plurality of merchants 120, plurality of users 130, and/or plurality of recipients 140. For example, database 118 may store information associated with the identities and locations of one or more of plurality of merchants 120, so that a user of plurality of users 130 can arrange for picking up the parcel from the merchant for delivery. In some cases, parcels may be picked up by plurality of users 130 from a central location, such as a distribution hub or other shipping facility, where the parcels are stored or held for delivery to recipients.

Database 118 may store information associated with the identities of one or more of plurality of plurality of users 130, so that the particular user delivering a parcel for a merchant may be identified. In addition, in some embodiments, database 118 may also store information associated with historical parcel deliveries completed by each user of plurality of users 130, including but not limited to ratings, feedback (e.g., complaints about damaged parcels, poor recipient experiences, etc.), and/or various delivery performance parameters (e.g., time to deliver, numbers of deliveries, etc.).

Database 118 may also include information about plurality of recipients 140, including identities, delivery addresses, contact information, delivery notes (e.g., where to leave deliveries, access gate or door codes, etc.). Database 118 may store other information to facilitate the delivery exchange service infrastructure, including but not limited to account information for plurality of merchants 120 and/or plurality of users 130 (e.g., for payment of delivery fees from merchants 120 to users 130), usernames or other identification associated with plurality of merchants 120 and/or plurality of users 130, merchant and/or user preferences, etc.

The example embodiments described herein are directed to parcel deliveries to one or more of recipients 140. A parcel may include any type of package that is sent to a recipient and may include, but is not limited to consumer goods, packaged or prepared food (such as from grocery stores or restaurants), personal items, and other objects or articles that may be transported using delivery services.

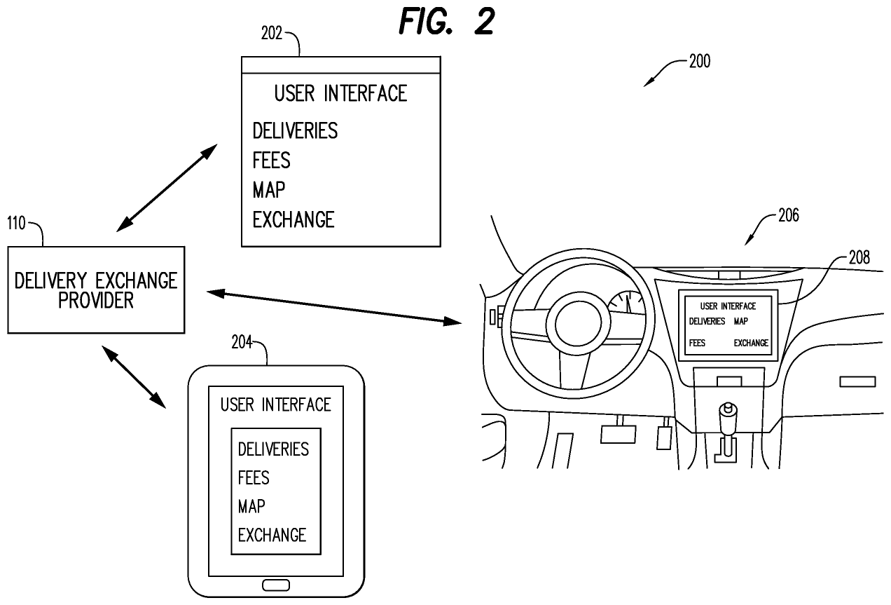

Referring now to FIG. 2, example embodiments of different user interfaces 200 for plurality of users 130 of the delivery exchange service infrastructure are shown. As described above, in some embodiments, a user (e.g., one or more of plurality of users 130) may use user interfaces 200 to interact with user interface 114 at delivery exchange service provider 110, which may be a mobile app or website. In an example embodiment, user interfaces 200 may include a first user interface 202 in the form of a website. User interfaces 200 may also include a second user interface 204 may be in the form of an application on a mobile device, such as a smartphone or tablet. User interfaces 200 may also include a third user interface 206 in the form of an in-vehicle application or a graphic user interface (GUI) accessible on a vehicle display screen 208.

In each case, user interfaces 200 may include a menu with a variety of choices or selections, including, but not limited to information about deliveries (e.g., parcels for delivery), fees (e.g., fees associated with a parcel delivery), map (e.g., showing locations of merchants and/or recipients), and an exchange option (e.g., allowing a user to trade or exchange an existing delivery with another user). It should be understood that the examples of user interfaces 200, including first user interface 202, second user interface 204, and/or third user interface 206, are merely exemplary and other forms for user interfaces 200 may be provided to allow a user to interact with user interface 114 at delivery exchange service provider 110.

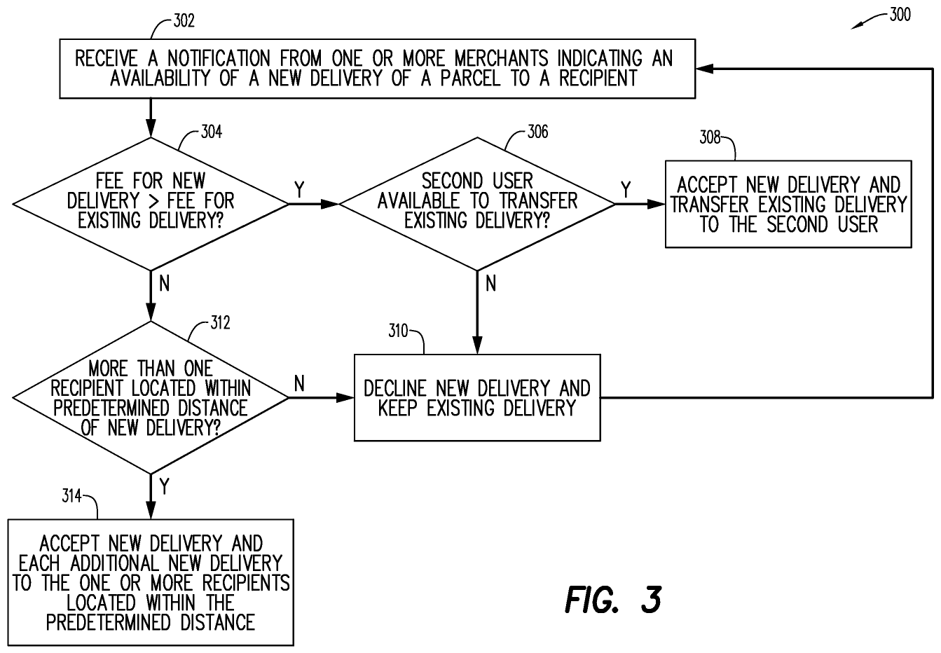

Referring now to FIG. 3, a flowchart of an example embodiment of a method 300 for a delivery exchange service according to the techniques described herein is illustrated. In some embodiments, method 300 may be implemented by at least one processor of a computing device, for example, processor 112 at delivery exchange service provider 110 and/or a processor associated with a mobile device of a user (e.g., a smartphone or tablet). In an example embodiment, method 300 may be implemented by a processor associated with a mobile device of a user of plurality of users 130.

In some embodiments, method 300 may be implemented when a user of plurality of users 130 has already accepted at least one existing delivery to a recipient for an associated fee. Method 300 may be used so that users can determine which deliveries will generate the highest fees so that lower-paying deliveries may be exchanged with other users who can deliver the parcel at a lower cost.

In this embodiment, method 300 may begin with an operation 302. At operation 302, a notification is received from one or more merchants indicating an availability of a new delivery of a parcel to a recipient. For example, at operation 302, a user of plurality of users 130 may receive an alert on second user interface 204 on the user's mobile device from delivery exchange service provider 110 that one of plurality of merchants 120 has a new delivery of a parcel to a recipient of plurality of recipients 140 available for acceptance. In some embodiments, the notification at operation 302 may also include information associated with the new delivery, such as the location of the parcel for pickup, the location of the recipient for delivery, an associated fee for the delivery, information about whether the delivery is time sensitive (i.e., food deliveries in particular may be required to be delivered within a predetermined time window), and other relevant information to allow the user to determine details of the delivery.

Next, method 300 proceeds to an operation 304. At operation 304, whether a fee for the new delivery is greater than a fee for an existing delivery is determined. For example, as described above, a user of plurality of users 130 may have already accepted at least one existing delivery to a recipient for an associated fee. This fee for the existing delivery is compared with the fee for the new delivery to a new recipient at operation 302 so that the user can determine which fee will pay more for completing the delivery.

Upon determining at operation 304 that the fee for the new delivery is more than the fee for the existing delivery (e.g., the result of operation 304 is Y for “YES”), then method 300 proceeds to an operation 306. At operation 306, whether or not a second user is available to transfer the existing delivery to is determined. That is, at operation 306, method 300 requires that in order for the user to accept the new delivery with the higher fee, the user must find a new user of plurality of users 130 (i.e., a second user) to accept the existing delivery. For example, the user may re-list or re-post the existing delivery through delivery exchange service provider 110 to find the second user to transfer the existing delivery.

Upon determining at operation 306 that a second user is available to transfer the existing delivery (e.g., the result of operation 306 is Y for “YES”), then method 300 proceeds to an operation 308. At operation 308, the user may then accept the new delivery and the existing delivery is transferred to the second user. That is, the second user takes responsibility for completing the existing parcel delivery to the existing recipient. In some cases, operation 306 may include offering to transfer the fee for the existing delivery to the second user. In other cases, operation 306 may include the user offering an extra fee in addition to the fee for the existing delivery as an incentive to transfer the existing delivery to the second user.

Upon determining at operation 306 that a second user is not available to transfer the existing delivery (e.g., the result of operation 306 is N for “NO”), then method 300 proceeds to an operation 310. At operation 310, the new delivery is declined and the user keeps the existing delivery to the existing recipient. With this arrangement, method 300 prevents users from abandoning or returning parcel deliveries that they have already accepted to take higher-paying deliveries.

In some cases, a user may combine two or more parcel deliveries within a similar geographic area so that the combined fee is more than the fee for a single parcel delivery. Returning to operation 304 of method 300, upon determining that the fee for the new delivery is not is more than the fee for the existing delivery (e.g., the result of operation 304 is N for “NO”), then method 300 proceeds to an operation 312. At operation 312, whether there is more than one recipient of an available parcel delivery located within a predetermined distance of a location of the new delivery is determined. For example, if additional recipients of parcel deliveries are within the predetermined distance of the location of the new delivery, then it may be more efficient and cost-effective for a user to accept two or more lower paying delivery fees that will combine for a greater fee than a single higher-paying fee for the existing delivery. In some embodiments, the user may set the predetermined distance in advance (e.g., within the user's preferences saved at database 118 of delivery exchange service provider 110). In other embodiments, the user may manually set the predetermined distance upon receiving the notification of the new delivery, for example, through one of user interfaces 200, described above.

Upon determining at operation 312 that there is not more than one recipient located within the predetermined distance of the new delivery (e.g., the result of operation 312 is N for “NO”), then proceeds to operation 310 where the new delivery is declined and the user keeps the existing delivery to the existing recipient.

Alternatively, at operation 312, method 300 may include determining whether or not the new delivery is within a predetermined distance of the existing delivery. For example, if the new delivery is close to (i.e., within the predetermined distance) of the existing delivery, the user may accept the new delivery without transferring the existing delivery and receive both the fee for the new delivery and the fee for the existing delivery, without needing to travel a significant additional distance.

Upon determining at operation 312 that there is more than one recipient located within the predetermined distance of the new delivery (e.g., the result of operation 312 is Y for “YES”), then proceeds to an operation 314. At operation 314, the user accepts the new delivery and each additional new delivery to the one or more recipients located within the predetermined distance. With this arrangement, the user may combine two or more lower-paying fees for deliveries within a similar geographic area (e.g., within the predetermined distance) for a combined fee that is more than the fee for a single parcel delivery.

In some cases, operation 314 may also require the user to find a second user that is available to transfer the existing delivery to before allowing the user to accept the new deliveries at operation 314, for example, as described above in reference to operation 306. If a second user is not available, method 300 may prevent or prohibit the user from accepting the new deliveries at operation 314 so that the user does not abandon or return the existing parcel delivery that they have already accepted.

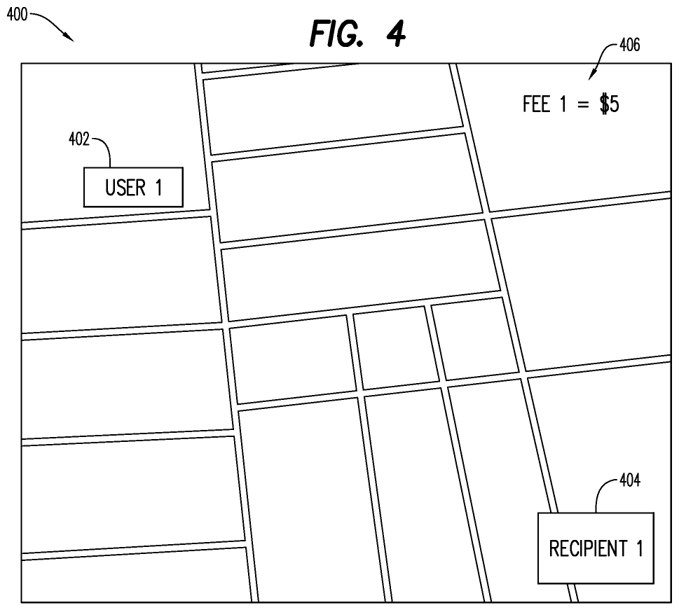

FIGS. 4 through 8 illustrate example scenarios of implementing the delivery exchange service according to the techniques described herein. In the example scenarios, a user of plurality of users 130 may implement method 300 as described above. It should be understood, however, that the delivery exchange service infrastructure according to the example embodiments may be used by more than one user at a time. That is, the system and method of providing a delivery exchange service described herein can include multiple users implementing method 300 at any given time.

Referring now to FIG. 4, an example scenario 400 of a user using the delivery exchange service is illustrated. In scenario 400, a first user 402 of plurality of users 130 is using the delivery exchange service provided by delivery exchange service provider 110 to deliver one or more parcels to recipients. For example, in scenario 400, first user 402 has an existing delivery of a parcel to a first recipient 404 of plurality of recipients 140. The existing delivery of the parcel to first recipient 404 is associated with a first fee 406, for example, in the amount of $5.

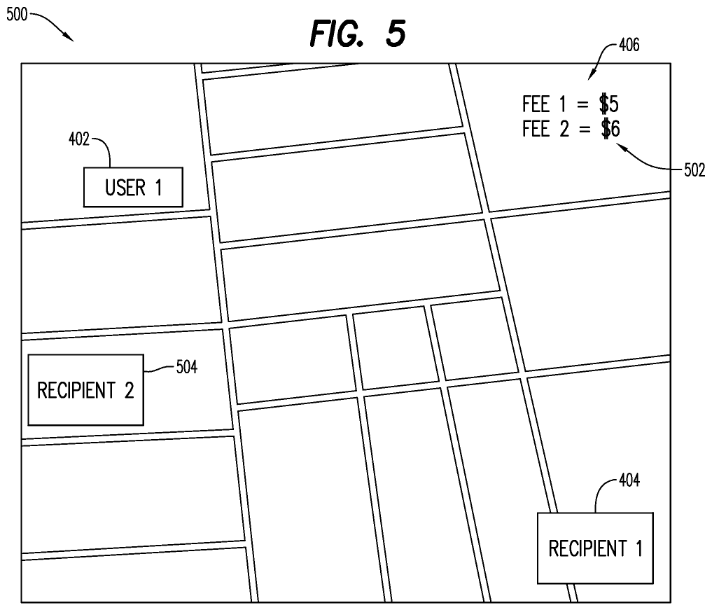

Referring next to FIG. 5, an example scenario 500 of first user 402 receiving an alert of a higher-paying delivery by the delivery exchange service is illustrated. In scenario 500, while first user 402 has already accepted the existing delivery of the parcel to first recipient 404 (e.g., in exchange for first fee 406), delivery exchange service provider 110 may send a notification or alert to first user 402 to inform them of a new delivery to a new recipient (e.g., a second recipient 504). For example, the notification or alert may be sent by delivery exchange service provider 110 to a mobile device of first user 402, as described above in reference to operations of method 300.

As shown in scenario 500, the notification or alert from delivery exchange service provider 110 informs first user 402 that the new delivery of a parcel to second recipient 504 has an associated second fee 502, for example, in the amount of $6. In this embodiment, the new fee for the new delivery to second recipient 504 (e.g., second fee 502 in the amount of $6) is more than the existing fee for the existing delivery to first recipient 404 (e.g., first fee 406 in the amount of $5). In response, first user 402 may exchange the existing delivery to first recipient 404 and accept the new delivery to second recipient 504, as detailed above in reference to operations of method 300.

In order for first user 402 to accept the new delivery to second recipient 504, however, delivery exchange service provider 110 may require that first user 402 exchange the existing delivery to first recipient 404 with another user of plurality of users 130. For example, as described above with reference to operations of method 300.

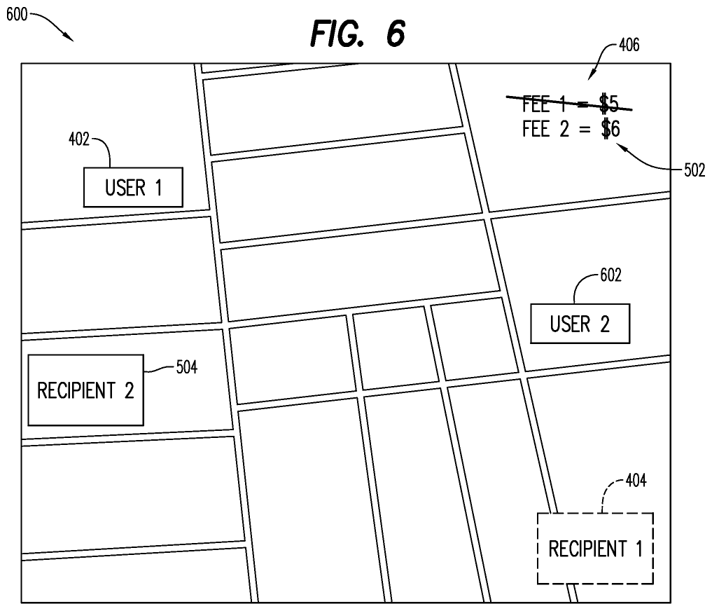

Referring now to FIG. 6, an example scenario 600 of first user 402 using the delivery exchange service to exchange a lower-paying delivery for a higher-paying delivery is illustrated. In scenario 600, first user 402 has identified an available user to whom the existing delivery to first recipient 404 may be exchanged or transferred. For example, as shown in scenario 600, first user 402 may exchange or transfer the existing delivery to first recipient 404 to a second user 602 of plurality of users 130, along with the associated first fee 406. First user 402 may then accept the new delivery to second recipient 504 for the associated higher-paying second fee 502.

With this arrangement, the delivery exchange service described herein allows users to determine which deliveries will generate the highest fees so that lower-paying deliveries may be exchanged with other users who can deliver the parcel at a lower cost. In addition, by requiring a user to exchange or trade an existing delivery to another user before accepting a new delivery, the delivery exchange service prevents users from abandoning or returning parcel deliveries that they have already accepted to take higher-paying deliveries. In this manner, parcel deliveries to recipients can be provided in a manner that is cost-effective and efficient.

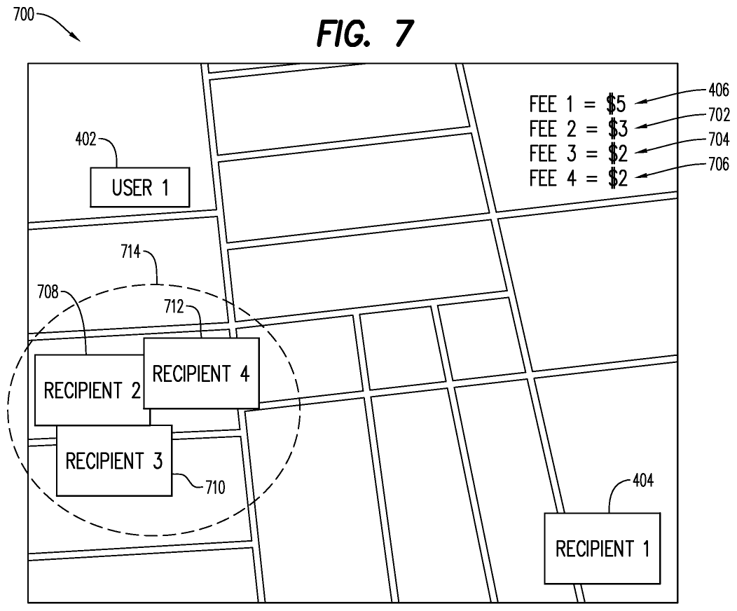

In some embodiments, a user may combine two or more lower-paying deliveries to multiple recipients that are located within a similar geographic area so that the combined fee for the two or more deliveries is more than a single fee to only one recipient. Referring now to FIG. 7, an example scenario 700 of a user receiving an alert of a combined delivery by delivery exchange service 110 is illustrated. In scenario 700, first user 402 has already accepted the existing delivery of the parcel to first recipient 404 (e.g., in exchange for first fee 406). In this embodiment, delivery exchange service provider 110 may send a notification or alert to first user 402 to inform them of a new delivery to at least one new recipient (e.g., a second recipient 708), as described above in reference to operations of method 300. The associated second fee 702 for the new delivery to second recipient 708 is, for example, in the amount of $3. Accordingly, second fee 702 for the new delivery to second recipient 708 is not more than the first fee 406 in the amount of $5 for the existing delivery to first recipient 404.

In scenario 700, however, more than one recipient is located within a predetermined distance 714 of the location of the new delivery to second recipient 708, including at least a third recipient 710 and/or a fourth recipient 712. For example, predetermined distance 714 may be less than one mile or other distance selected or determined by first user 402. The additional new delivery to third recipient 710 has an associated third fee 704 in the amount of $2 and the additional new delivery to fourth recipient 712 has an associated fourth fee 706 also in the amount of $2.

In scenario 700, none of the associated fees for the new deliveries to any one of second recipient 708 (second fee 702 in the amount of $3), third recipient 710 (third fee 704 in the amount of $2), or fourth recipient 712 (fourth fee 706 in the amount of $2) alone is more than the existing fee for the delivery to first recipient 404 (first fee 406 in the amount of $5). However, in scenario 700, because all of second recipient 708, third recipient 710, and fourth recipient 712 are located with the same or similar geographic area (e.g., within predetermined distance 714 of each other), first user 402 may be able to deliver parcels to second recipient 708, third recipient 710, and fourth recipient 712 without significant additional driving or time so that the combined fee in the amount of $7 (e.g., the sum of second fee 702, third fee 704, and fourth fee 706) is more than the first fee 406 in the amount of $5 to deliver the single parcel to first recipient 404.

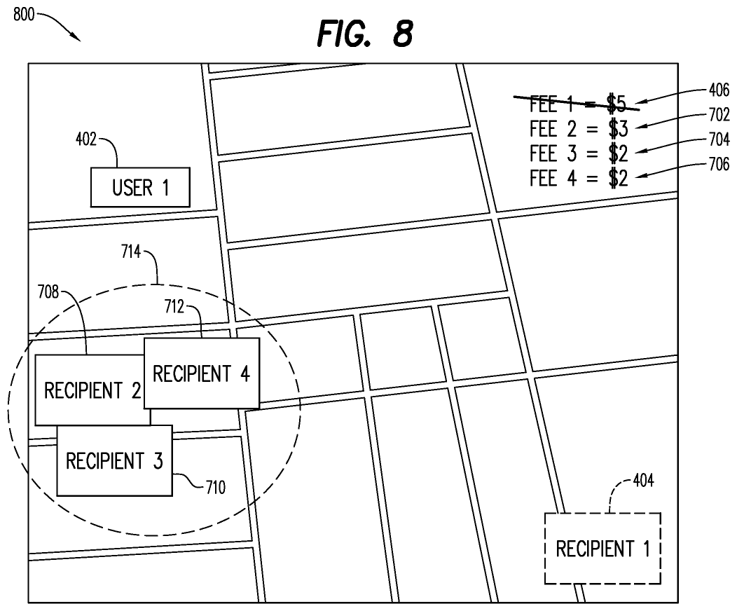

As shown in FIG. 8, an example scenario 800 illustrates first user 402 using the delivery exchange service to exchange the single delivery for a combined delivery. In scenario 800, first user 402 has determined that the combined fee for the combined parcel deliveries to second recipient 708, third recipient 710, and fourth recipient 712 is more than the first fee 406 to deliver the single parcel to first recipient 404 (i.e., combined fees 702, 704, 706 in the amount of $7 is more than first fee 406 in the amount of $5). In response, first user 402 has accepted the new delivery to second recipient 708 and each of the additional new deliveries to the other recipients located within predetermined distance 714 (e.g., additional new deliveries to third recipient 710 and fourth recipient 712). Accordingly, as shown in scenario 800, by using the delivery exchange service of the example embodiments, first user 402 receives a higher-paying combined fee for delivery to the combined recipients (e.g., recipients 708, 710, 712) than first fee 406 for delivery to first recipient 404.

Additionally, in some cases of scenario 800, delivery exchange service provider 110 may require first user 402 to identify an available second user to whom to exchange or transfer the existing delivery to first recipient 404 before first user 402 is permitted to accept the combined parcel deliveries to second recipient 708, third recipient 710, and fourth recipient 712, for example, as described above in reference to method 300.

While various embodiments have been described, the description is intended to be exemplary, rather than limiting and it will be apparent to those of ordinary skill in the art that many more embodiments and implementations are possible that are within the scope of the claims. Additionally, one or more of the various embodiments described above may be combined in part or in whole in accordance with the principles described herein. Accordingly, the embodiments are not to be restricted except in light of the attached claims and their equivalents. Also, various modifications and changes may be made within the scope of the attached claims.

1. A method for providing a delivery exchange service, the method comprising:
receiving, at a user interface associated with a first user, a notification from at least one merchant indicating an availability of a new delivery of a parcel to a recipient;
comparing a fee for the new delivery to a fee for an existing delivery;
upon determining that the fee for the new delivery is more than the fee for the existing delivery, determining whether a second user is available to receive a transfer of the existing delivery; and
upon determining that the second user is available, accepting the new delivery and transferring the existing delivery to the second user.

2. The method according to claim 1, wherein the user interface is associated with a mobile device of the first user.

3. The method according to claim 1, wherein upon determining that the second user is not available, the method further comprises declining the new delivery and keeping the existing delivery.

4. The method according to claim 1, further comprising:
upon determining that the fee for the new delivery is not more than the fee for the existing delivery, determining whether more than one recipient is located within a predetermined distance of a location of the new delivery.

5. The method according to claim 4, wherein upon determining that the more than one recipient is located within the predetermined distance, the method further comprising accepting each new delivery to one or more recipients located within the predetermined distance.

6. The method according to claim 5, wherein the predetermined distance is selected by the first user.

7. The method according to claim 5, wherein a combined fee for all of the new deliveries to the one or more recipients located within the predetermined distance is more than the fee for the existing delivery.

8. The method according to claim 5, further comprising:
requiring the first user to transfer the existing delivery to a second user prior to allowing the first user to accept the new deliveries to the one or more recipients located within the predetermined distance.

9. A system for providing a delivery exchange service infrastructure, the system comprising:
a delivery exchange service provider, the delivery exchange provider including at least one processor, a user interface, a communication interface, and a database;
a plurality of merchants in communication with the delivery exchange service provider, each merchant of the plurality of merchants having parcels for delivery to one or more recipients; and
a plurality of users in communication with the delivery exchange service provider, each user of the plurality of users accepting a fee for delivery of a parcel to the one or more recipients;
wherein the delivery exchange service provider:
sends a notification to at least one user of the plurality of users indicating an availability of a new delivery of a parcel from at least one of the plurality of merchants to a recipient.

10. The system according to claim 9, wherein the at least one user receives the notification from the delivery exchange service provider on a user interface.

11. The system according to claim 10, wherein the user interface is associated with at least one of a website, an application on a mobile device, or a graphical user interface accessible on a vehicle display screen.

12. The system according to claim 9, wherein, upon the at least one user accepting the new delivery, the delivery exchange service provider requires that the existing delivery is transferred to a second user of the plurality of users.

13. The system according to claim 9, wherein the notification includes more than one recipient located within a predetermined distance of the new delivery.

14. The system according to claim 13, wherein the at least one user selects the predetermined distance.

15. The system according to claim 9, wherein the plurality of users provide last-mile delivery to the one or more recipients from another delivery service provider.

16. A method for providing a delivery exchange service, the method comprising:
receiving, at a user interface associated with a first user, a notification from at least one merchant indicating an availability of a new delivery of a parcel to a first recipient;
comparing a fee for the new delivery to a fee for an existing delivery;
upon determining that the fee for the new delivery is not more than the fee for the existing delivery, determining whether more than one recipient is located within a predetermined distance of a location of the new delivery to the first recipient; and
upon determining that the more than one recipient is located within the predetermined distance, accepting each new delivery to one or more recipients located within the predetermined distance.

17. The method according to claim 16, wherein a combined fee for all of the new deliveries to the one or more recipients located within the predetermined distance is more than the fee for the existing delivery.

18. The method according to claim 16, wherein the predetermined distance is selected by the first user.

19. The method according to claim 16, further comprising:
requiring the first user to transfer the existing delivery to a second user prior to allowing the first user to accept the new deliveries to the one or more recipients located within the predetermined distance.

20. The method according to claim 16, wherein the user interface is associated with at least one of a website, an application on a mobile device, or a graphical user interface accessible on a vehicle display screen.
